(19) United States
(12) Patent Application Publication
(10) Pub. No.: US 2017/0133126 A1
(43) Pub. Date: May 11, 2017

(54) CABLE, METHOD FOR MANUFACTURING A CABLE, RIBBON LEAD ELEMENT, METHOD FOR MANUFACTURING A RIBBON LEAD ELEMENT AND MOTOR VEHICLE USING THE CABLE

(71) Applicant: LEONI KABEL GMBH, Nuernberg (DE)

(72) Inventors: RAINER POEHMERER, WINKELHAID (DE); JOHANNES NACHTRAB, WINDSBACH (DE); ERWIN KOEPPENDOERFER, SCHWABACH (DE); DOMINIK DORNER, PLEINFELD (DE); MICHAEL FEIST, SCHWABACH (DE)

(21) Appl. No.: 15/344,763

(22) Filed: Nov. 7, 2016

(30) Foreign Application Priority Data
Nov. 6, 2015 (DE) 10 2015 221 855.4

(51) Int. Cl. H01B 11/18; H01B 13/016; H01B 13/06; H01B 7/08

(52) U.S. Cl. CPC H01B 11/1821; H01B 7/0823; H01B 13/0165; H01B 13/06

(57) ABSTRACT

A cable, in particular a data cable, which extends in a longitudinal direction, includes a central element which is surrounded, in particular encased, by a ribbon lead element. The ribbon lead element has two film layers as well as a plurality of leads, in particular conductor elements, which are disposed between the film layers. A method for manufacturing a cable, a ribbon lead element, a method for manufacturing a ribbon lead element and a motor vehicle using the cable are also provided.

### CROSS-REFERENCE TO RELATED APPLICATION

This application claims the priority, under 35 U.S.C. §119, of German Patent Application DE 10 2015 221 855.4, filed Nov. 6, 2015; the prior application is herewith incorporated by reference in its entirety.

### BACKGROUND OF THE INVENTION

### Field of the Invention

The invention relates to a cable, in particular a data cable, a ribbon lead element and respective methods for their manufacture. The invention also relates to the use of such a data cable in a vehicle for transportation on land, water, in space and/or in the air such as e.g. motor vehicles, aircraft, ships, boats or hovercraft, etc. In order to avoid unnecessary repetitions, reference is made below to a motor vehicle, although it is not intended to constitute a restriction with respect to use in a vehicle for transportation.

The increasing use of communication technology within motor vehicles means that the demand for cost-effective data leads for relatively high transmission rates is also increasing. In particular, the USB 3.1 standard is also becoming increasingly accepted.

Such standards make stringent requirements of the data transmission channel which is referred to as the “physical layer” and which is used not only to ensure the transmission of data packets over a number of data transmission paths but also frequently to ensure power supply and transmission of possibly present sensor currents as well as the transmission of optical information.

In order to be able to satisfy those requirements, widespread basic technologies can be combined. Those basic technologies are typically not optimized for the described hybrid line configurations but instead are optimized for a stand-alone method of functioning, independent of other elements, in a pure form. For example, in the case of a USB 3.1 cable, four individual conductor elements are therefore twisted with four coaxial leads, wherein the coaxial leads are usually composed of inner conductors in the form of stranded conductors, a solid or foamed dielectric, an outer conductor which is embodied as a film or foil shield, braided shield, helical shield or a combination of the abovementioned elements as well as a sheath. Additionally, such a lead includes an overall shield for the same implementation possibilities as those mentioned above, as well as an overall sheath, for mechanical and chemical reasons. It is disadvantageous with that configuration that neither the fabrication technology nor the subelements as such are optimized for the task described above. In addition, fabrication and pre-assembly are frequently costly, which gives rise to relatively high costs.

Overall, there is therefore frequently a conflict of objectives in terms of the most cost-effective and most compact configuration possible and the lowest possible mutual influencing of the individual leads and/or conductor elements of the (data) cable.

### SUMMARY OF THE INVENTION

It is accordingly an object of the invention to provide a cable, in particular a data cable, a method for manufacturing a cable, a ribbon lead element, a method for manufacturing a ribbon lead element and a motor vehicle using the cable, which overcome the hereinafore-mentioned disadvantages of the heretofore-known cables, ribbon lead elements, methods and motor vehicles of this general type, in which the cable is as compact as possible and as cost-effective as possible and with which reliable data transmission is ensured and, in particular, e.g. effects of crosstalk and/or interference are reduced or entirely eliminated as far as possible, even at high data rates and in which the ribbon lead element can be used, in particular, for manufacturing such a cable.

With the foregoing and other objects in view there is provided, in accordance with the invention, a cable or data cable extended in a longitudinal direction, comprising a central element and a ribbon lead element surrounding or encasing the central element. The ribbon lead element has two film or foil layers and a plurality of leads or conductor elements disposed between the film layers.

With the objects of the invention in view, there is also provided a method for manufacturing a cable. The method comprises providing a central element, providing a ribbon lead element including two film layers and a plurality of leads disposed between the film layers, and surrounding or encasing the central element with the ribbon lead element.

With the objects of the invention in view, there is furthermore provided a ribbon lead element for a cable. The ribbon lead element comprises two film layers, and a plurality of leads disposed between the film layers.

With the objects of the invention in view, there is additionally provided a method for manufacturing a ribbon lead element. The method comprises providing two film layers, placing a plurality of leads between the two film layers, and interconnecting or punctiform bonding the film layers to one another.

With the objects of the invention in view, there is concomitantly provided a motor vehicle, comprising a cable according to the invention.

Advantageous refinements, developments and variants are the subject matter of the dependent claims.

The advantages and developments mentioned in relation to the cable apply correspondingly also to the ribbon lead element and to the methods, and vice versa. Likewise, the advantages and developments mentioned in relation to one of the methods apply correspondingly also to the other method, and vice versa.

The cable is embodied, in particular, as a data cable. The cable extends in a longitudinal direction and has a central element which is surrounded, in particular encased, by a ribbon lead element. The ribbon lead element has two film layers, i.e. films as well as a number of leads, in particular conductor elements, which are disposed between the film layers.

Ribbon-shaped lead elements are described, for example, in U.S. Pat. No. 8,946,558 B2, German Patent DE 35 22 173 C1 and U.S. Pat. No. 4,596,897.

The advantages which are achieved with the invention include, in particular, the fact that a particularly cost-effective and compact cable is formed which is suitable, in particular, as a data lead and, in particular, as a USB cable. In this context, in particular a number of leads, which serve, in particular, for transmitting data or signals, are accommodated in the central element and in the ribbon lead. Advantageously any previously available cable can be used as a central element, with the result that the ribbon lead element permits simple expansion of existing and possibly already standardized cables in the sense of an upgrade.

The ribbon lead element is embodied in the manner of a ribbon and is particularly thin, with the result that it constitutes a particularly small addition to the central element and gives rise to only an insignificantly increased spatial requirement. The thickness of the ribbon lead element is determined, in particular, substantially by the diameter of the leads which are disposed between the film layers. Between the leads, the film layers bear, in particular, one against the other and therefore form overall a flat ribbon in which the leads form corresponding elevations or fins which extend, in particular, in the longitudinal direction.

A further advantage is that, in particular, the cable is particularly easy to fabricate. The central element and the ribbon lead element are each suitably made available as a semi-finished product and the ribbon lead element is then positioned, wound or wrapped around the central element. Due to the ribbon-shaped configuration, the ribbon lead element is particularly easy to process.

In this context, preferably different types of ribbon lead elements are used, referred to below as ribbon lead elements of coaxial symmetrically shielded and symmetrically non-shielded type. These are used, in particular, for hybrid leads with high or low data rates. A core concept is then, on one hand, to optimize the ribbon lead elements and, on the other hand, to use the ribbon lead elements adapted to the application, in order to implement and construct hybrid lead configurations.

According to one preferred configuration, the ribbon lead element is embodied as a coaxial ribbon lead element with a number of coaxial elements. For this purpose, the film layers are embodied as metal-lined film layers, each with a conductive side, and the leads are embodied as an inner structure of a coaxial conductor, each having an inner conductor which is surrounded by a dielectric. The conductive sides of the film layers are electrically conductively connected one on top of the other, i.e. facing one another, and as a result form a common outer conductor for the coaxial elements. A respective lead then forms a coaxial element in combination with the conductive sides of the film layers.

A conventional coaxial lead is generally composed of an, in particular, solid or stranded inner conductor which is surrounded by a solid or foamed dielectric, an outer conductor and a sleeve. The dielectric is typically fabricated from the materials PP, PE, XPE or FEP. The outer conductor is, in particular, formed from a metal foil, a metal-lined plastic film, a wire mesh, a helix or a conductively embodied combination of a plurality of the above-mentioned elements. The sleeve is embodied in an at least galvanically isolating fashion, i.e. in particular insulating, and e.g. as a plastic film, extruded cable sheath or the like.

If a plurality of such coaxial conductors are positioned without the galvanically isolating sleeve in such a way that the outer conductors are each electrically conductively connected to one another, a so-called coaxial ribbon lead is obtained.

With respect to a simple configuration, there is no provision for the coaxial ribbon lead element to be constructed from a plurality of parallel coaxial conductors having outer conductors which are at the same electrical potential. In this context, as described above, a plurality of inner structures of a coaxial conductor, each having an inner conductor and a dielectric, are used in combination with a common outer conductor. The common outer conductor is formed in this case by conductive layers of the films which are connected to one another. For this purpose, in particular metal-lined films are used which are expanded, in particular, with an adhesion layer, with the result that the necessary mechanical stability is ensured. The particular advantage is to be considered the fact that it is possible to dispense with the formation of individual outer conductors and it is, in particular also dispensed with.

According to one preferred alternative, the ribbon lead element is embodied as a symmetrically shielded ribbon lead element. In this context, the film layers are embodied as metal-lined film layers, each with a conductive side. In each case, two of the leads are combined to form a lead pair, in particular they are twisted with one another or disposed running parallel to one another. The conductive sides are only connected to one another outside the leads of a respective lead pair, in order to form shielded lead pairs.

In order to form a symmetrically shielded ribbon lead element, in each case one lead pair is enclosed in a sandwich-like fashion between the conductive sides of the films, with the result that the conductive sides form a pair shield for the lead pair. In this context, the leads, in particular conductor elements, are therefore applied, i.e. disposed, in such a way that there is no separating shield element located between them. The lead pair forms a transmission pair through which preferably symmetrical transmission of data takes place.

Accordingly, symmetrical operation of a shielded pair can be implemented, together with suitable plug-side wiring of the elements, wherein the shielding is provided in this case by using the film shield.

The lead pairs are, in particular, non-twisted conductor elements which are disposed in parallel one next to the other. Alternatively, the conductor elements of a pair are twisted with one another.

According to a further preferred alternative, the ribbon lead element is embodied as a symmetrically non-shielded ribbon lead element. The film layers are embodied as non-conductive film layers and the leads are non-shielded. Preferably, in each case two of the leads are combined, in particular twisted with one another, to form a non-shielded lead pair. The configuration of the symmetrically non-shielded ribbon lead element is comparable with the symmetrically shielded ribbon lead element, with the difference that no shielding is provided by the films, that is to say in particular no metal-lined films are used. The, in particular, insulating films are therefore merely connected to one another so as to adhere in a punctiform fashion or alternatively over the entire surface. By suitably setting a lateral distance between the individual lead pairs, in particular the crosstalk from data pair to data pair is then controlled, which is to be taken into account for many applications.

The ribbon lead elements are manufactured by using the, in particular, parallel orientation of two films which are metal-lined or non-metal-lined depending on the configuration and between which the individual leads, i.e. in particular conductor elements or inner structures are inserted in the manner of a sandwich in pairs or individually as is suitable. In the case of the first two variants, i.e. in the case of a coaxial or symmetrically shielded ribbon lead element, the films have a conductive layer, wherein the conductive layers are located opposite one another and are electrically connected to one another.

In addition to the leads, conductor elements, inner structures and/or coaxial elements, a non-insulated conductor is advantageously also introduced, e.g. a wire or stranded conductor or a metal thread, forming electrical contact with the “sandwich shield,” i.e. the two metalized surfaces of the metal-lined films which are located opposite one another, i.e. the two conductive sides of the film layers which are located opposite one another.

Through the use of correspondingly shaped rollers, these, in particular, three layers, i.e. the film layers and the leads, of the ribbon lead element are generally brought together activated thermally or in some other way. For example, the rollers are embodied similarly to a calendar. The rollers also have, in particular, devices which set in action, i.e. activate, the adhesive effect of an adhesion layer. For example, a thermal mechanism for adhesives which can be activated thermally is used. An adhesion layer is applied, for example, to one of the film layers or to both film layers.

In these configurations, due to the adhesion layer which under certain circumstances is a conductive adhesive layer, in the overlapping region of the film layer which is applied from above and from below, there is possibly no low-impedance electrically conductive connection implemented between the lower and upper metallic layers. This is preferably prevented by virtue of the fact that the, in particular, polymer carrier layer of the film layer and/or the adhesive material, i.e. in particular adhesive, is not applied over the entire surface but rather in the form of a grid. The adhesion layer is therefore correspondingly not applied over the entire surface but rather in the form of a grid. As a result, in the overlapping region of the common film shield between the layers of the two film layers, an electrically conductive connection is brought about by frictional engagement. As a result, in particular, the DC resistance of the outer conductor is reduced which also results, in particular, in a reduction in the insertion loss, which is an important product feature of the data transmission leads.

In one expedient configuration, the ribbon lead element is wound, that is to say wrapped, around the central element. As a result, a sufficient (bending) flexibility of the cable is ensured.

The central element preferably has a plurality of leads, in particular data leads or even leads for power supplies. Both the leads of the central element and the leads of the ribbon lead element are preferably constructed for the transmission of data. Alternatively, the central element is an element for optical transmission or an element for transmitting fluids or in the simplest case a cavity. In this case, the cable is preferably embodied as a waveguide, wherein the wall of the waveguide is formed by the ribbon lead element.

The cable is expediently embodied according to the USB standard, in particular according to the USB 3.1 standard. Both the central element and the ribbon lead element preferably each have 4 transmission elements.

Overall, the cable, in particular the ribbon lead element, is distinguished in a summarized form by the following features and properties:

A sandwich structure composed of two film layers and leads disposed between them. A respective film layer is a metal film, a metal-lined plastic film, a galvanically coated plastic film, an electrochemically coated plastic film or an electrostatically coated plastic film. A conductive or non-conductive adhesive layer is not applied to the film layer over the entire surface, i.e. is applied only partially, in order to improve the contact resistance between the base surface and the covering surface i.e. between the two film layers. The leads are, in particular, conductor elements and run between the film layers, i.e. between the base layer and the covering layer, in a uniform or non-uniform fashion, i.e. in particular at any desired distances from one another. The leads are suitably dimensioned, i.e. in particular with respect to the purpose of use provided. The leads are e.g. solid or foamed conductor elements. An, in particular, grill-like or grid-like electrical contact is formed between the metallic base surface and the metallic covering surface, between the leads running, in particular, parallel to one another. A ribbon lead element with such a sandwich structure is also referred to as a “coaxial ribbon lead” or as a “coaxial ribbon lead element.”

The above-mentioned grill or grid structure is embodied periodically or uniformly in a first variant, and in a second variant is, in contrast, e.g. embodied in a non-uniform fashion for mechanical, stearic or geometric reasons. Conversely, cutouts over a relatively large area, e.g. in the region of the profile of contact-forming aids are also conceivable.

The sandwich structure is preferably, but not exclusively, expanded with non-insulated conducting elements, e.g. a wire, a stranded conductor, a conductive thread, for forming contact with the conductive film which functions as an outer conductor.

Alternatively, the, in particular, grill-like or grid-like electrical contact between the metallic base surface and the metallic covering surface is produced and formed between every second lead of the leads which run, in particular, in a parallel fashion. As a result, in each case two leads, in particular conductor elements, are combined to form a lead pair, in particular a conductor element pair and are not shielded from one another, but are shielded with respect to other lead pairs. A ribbon lead element with such a structure is also referred to as a “symmetrically shielded ribbon lead” or as a “symmetrically shielded ribbon lead element.”

Alternatively, a respective film layer is a non-conductive (plastic) film. In this context, a spatial separation is produced at a suitable distance between every second lead, in particular conductor element, preferably running in parallel, as a result of the adhesive action of the base surface and the covering surface, with the function that two associated leads are permanently located one next to the other and form a data pair and that a permanent, fixedly installed distance is present between various data pairs. A ribbon lead element with such a structure is also referred to as a “symmetrically non-shielded ribbon lead” or as a “symmetrically non-shielded ribbon lead element.”

The sandwich structure is expediently expanded by a number of suitably embodied polymer fibers or glass fibers, for the transmission of optical signals.

The sandwich structure is expediently expanded by a number of suitably embodied conductor elements, for transmitting electrical power and signals without data transmission requirements.

The ribbon lead element expediently also has a number of flat conductor elements, i.e. the sandwich structure is expanded with a number of flat conductor elements.

In one advantageous configuration, the two film layers are each embodied as metal-coated or metal-lined film, each having a carrier film on which a metal layer is applied.

In a further advantageous configuration, the two metal layers are connected by using an adhesive which is preferably applied only on an area basis or section basis and, in particular, only in a punctiform fashion to one or both of the metal layers.

In a further advantageous configuration, a conductor, in particular a wire or stranded conductor, which is electrically connected to both metal layers and is placed in electrical contact therewith, is disposed between the two metal layers and, in particular, between two of the leads.

In a further advantageous configuration, the leads form a cross-sectional contour to which the film layers are adapted, wherein the film layers bear one against the other in the region between two respective leads. The term “adapted” is to be understood in this case as meaning, in particular, that the film layers follow the cross-sectional contour of the leads and therefore bear directly one against the other in a lead-free intermediate region between the leads.

In a further advantageous configuration, the two film layers are each a part of a common film which is folded, in particular folded longitudinally, in order to form the two film layers.

In a further advantageous configuration, the leads are embodied as conductor element pairs, with two conductor elements which are, in particular, twisted with one another and which are preferably surrounded by a common lead sheath.

In a further advantageous configuration, the film layers are fabricated merely from an electrically insulating material, i.e. they do not have any electrically conductive layer.

In a further advantageous configuration, the ribbon lead element is wound around the central element.

During the manufacture, the ribbon lead element is preferably wound or longitudinally folded around the central element.

In a further advantageous configuration, the central element has a number of leads and both the leads of the central element and the leads of the ribbon lead element are constructed to transmit data.

In a further advantageous configuration, the central element has a number of leads which are twisted with one another to form a twisted assembly, wherein the ribbon lead element is preferably wound around the twisted assembly and/or an outer shield, for example a braided shield or helical shield, is applied to the ribbon lead element.

In a further advantageous configuration, the cable is embodied as a USB cable, in particular as a USB 3.1 cable, wherein the central element and the ribbon lead element each have preferably four conductors.

In a further advantageous configuration, the central element is embodied as a USB 2.0 cable.

The use of ribbon lead elements of a coaxial, symmetrically shielded and symmetrically non-shielded type is described below, in particular in accordance with the configurations mentioned above, for cables, data cables and hybrid leads, in particular for the implementation of USB 3.1 cable structures.

The optimized ribbon lead elements which are described above are advantageously used for cables, in particular data cables and, in particular, hybrid leads. Conductor elements which are constructed in a film-like fashion, i.e. ribbon lead elements, are distinguished, in particular, by virtue of the fact that, in the first instance, they can be fabricated particularly cost-effectively, in the second instance they can be applied with various technologies (e.g. running longitudinally or wound) and, in the third instance, they can be used for additional functions such as film shielding or as a separating film. These conductor elements are therefore suitably used in a corresponding way.

If a cable configuration or lead configuration requires a plurality of coaxial or symmetrical conductor elements which are constructed in the same way or in various ways without mutual dependence, the above-mentioned parallel fabrication approach is preferably used. As a result, in particular, cost advantages are obtained. The fabrication process described above is optimized and advantageously fully scalable due, in particular, to the fact that adhesive is not applied over an entire surface. In this context, the required number of, in particular, parallel data transmission elements of a coaxial and symmetrical type, as well as a film shield or separating film which is required with respect to the hybrid lead, are made available, in particular, in merely one fabrication run.

A further advantage of the use, described below, of these elements for leads is, in particular, the fact that e.g. as a result of winding of a substructure, i.e. in particular of a central element, with the ribbon lead element, the preferred bending direction is matched in an advantageously application-specific fashion. In the longitudinal direction, such ribbon lead elements naturally behave in a very rigid fashion, but the longitudinal directions of the finished hybrid lead and the ribbon lead elements which are used are expediently selected in such a way that they are not equal by suitably selecting the winding angle, and the preferred direction is therefore advantageously cancelled out. These elements are then preferably used as follows for hybrid lead configurations:

In a first use, the ribbon lead element is disposed in a longitudinally running-in process on a substructure of any desired shape. The longitudinal axis of the film layers and of the data pairs is preferably parallel to the longitudinal direction of the substructure. The required number of lead pairs, in particular data transmission pairs is attached in this case. The attachment takes place in a working step with the attachment of a film which is metal-lined on two sides as a film shield. This has, in particular, the advantage that the installation space is optimized, in particular by dispensing with the electrically insulating and mechanically protective effective outer sleeve, and in comparison with conventional paired or coaxial elements.

In a second use, the ribbon lead element is disposed in a winding process, in particular in the opposite direction to a possibly present twisting direction about a substructure which is of any desired shape. The film layers are wrapped around the twisted substructure in the opposite direction to the pitch of the twisting or with any desired pitch around the non-twisted substructure. The attachment takes place in a working step with the attachment of a film which is metal-lined on two sides as a film shield. This has, in particular, the advantage that the installation space is optimized, in particular by dispensing with the outer sleeve which is electrically insulating and has a mechanically protective effect.

In a third use, the ribbon lead element is attached in a wrapping process in the same direction as a possibly present twisting direction of a substructure which is of any desired shape. The film layers are wrapped around the twisted substructure in the same direction as the pitch of the twisting or with any desired pitch around the non-twisted substructure. The attachment takes place in a working process with the attachment of a film which is metal-lined on two sides as a film shield. This has, in particular, the advantage that the installation space is optimized, in particular by dispensing with the electrically insulating outer sleeve which has a mechanically protective effect and in comparison with conventional paired or coaxial elements.

In a fourth use, the procedure as mentioned above is adopted in a winding process, but with metallic braid or metallic helical winding which is applied in the same process step. As a result, in particular, a common outer shield is formed.

Various aspects of the specified uses are combined with one another in one variant.

Other features which are considered as characteristic for the invention are set forth in the appended claims.

Although the invention is illustrated and described herein as embodied in a cable, a method for manufacturing a cable, a ribbon lead element, a method for manufacturing a ribbon lead element and a motor vehicle using the cable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional view of a metal-lined film;

FIG. 2 is a cross-sectional view of a coaxial ribbon lead element during fabrication;

FIG. 3 is a cross-sectional view of a coaxial ribbon lead element after fabrication;

FIG. 4 is a cross-sectional view of a symmetrically shielded ribbon lead element during fabrication;

FIG. 5 is a cross-sectional view of a symmetrically shielded ribbon lead element after fabrication;

FIG. 6 is a cross-sectional view of a symmetrically non-shielded ribbon lead element during fabrication;

FIG. 7 is a cross-sectional view of a symmetrically non-shielded ribbon lead element after fabrication; and

FIG. 8 is a cross-sectional view of a cable.

### DETAILED DESCRIPTION OF THE INVENTION

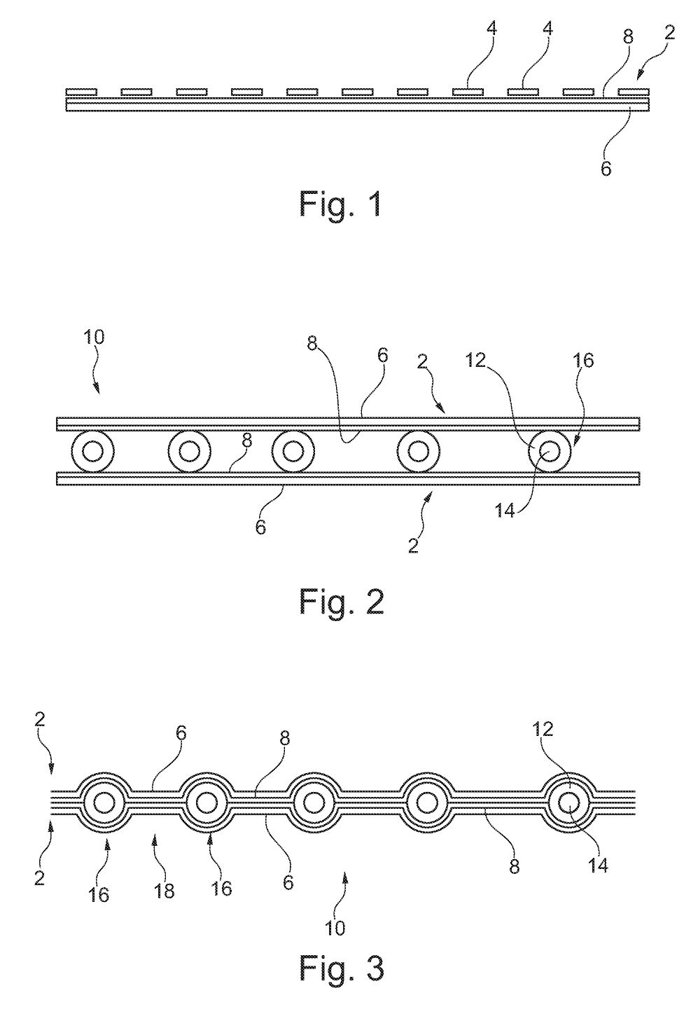

Referring now to the figures of the drawings in detail and first, particularly, to FIG. 1 thereof, there is seen a metal-lined film or foil layer 2, which is also merely referred to as a film, an adhesive layer 4 which is applied in a punctiform fashion, in order to ensure a reduction in electrical contact resistance in the case of mirror-inverted bonding of two such films 2 or alternatively in the case of longitudinal folding of such a film 2. The film 2 is composed of a carrier layer 6 and of a metal layer 8 which is applied thereto. The adhesive layer 4, which is also referred to as an adhesion layer, is applied to the metal layer 8.

FIG. 2 shows a basic diagram of a coaxial type ribbon lead element 10, which is referred to for short as a ribbon lead, before a joining process. In this context, two metal-lined film layers 2 are disposed in a mirror-inverted fashion with respect to one another. In this context, the metal layers 8 face one another. In the embodiment shown, the ribbon lead element 10 has five coaxial inner conductors 12 which are located between the film layers 2 and are each surrounded by a dielectric 14. One inner conductor 12, with one respective dielectric 14, forms a lead 16. Further elements, e.g. conductors for forming contact with the metal layers, are dispensed with in this case for the sake of clarity. Likewise, the adhesive layer 4 which is applied in a punctiform fashion in FIG. 1, is not illustrated herein for the sake of clarity.

FIG. 3 shows a basic diagram of a ribbon lead element 10 of a coaxial type after the joining process, in particular after the joining of the configuration seen in FIG. 2, with two metal-lined film layers 2 in a mirror-inverted configuration and, in this case, with five coaxial inner conductors 12 which are located between them and which are each surrounded by a dielectric 14. Further elements such as conductors for forming contact with the metal layers 8 are dispensed with herein for the sake of clarity. Likewise, the adhesive layer 4 which is applied in a punctiform fashion in FIG. 1 is not illustrated herein for the sake of clarity. In FIG. 3 it becomes clear that intermediate spaces 18, in which the two film layers 2 bear one against the other and in this way shield the leads 16 from one another, are formed between the leads 16.

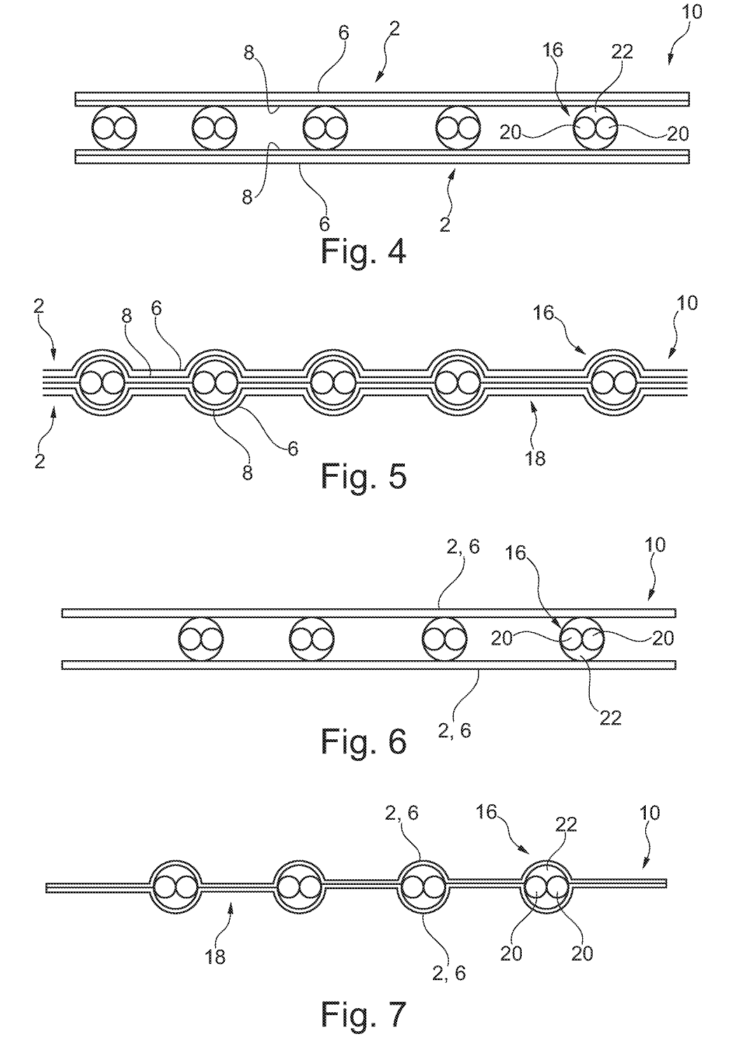

FIG. 4 shows a basic diagram of a ribbon lead element 10 of a symmetrically shielded type before the joining process, with metal-lined film layers 2 in a mirror-inverted configuration. Five leads 16 are disposed between the film layers 2. The leads 16 are embodied as symmetrical pairs in this case, specifically they are each embodied as two conductor elements 20 which are surrounded by a common conductor element sleeve 22. Further elements, e.g. conductors for forming contact with the metal layers 8, are dispensed with in this case for the sake of clarity. Likewise, the adhesive layer 4 which is applied in a punctiform fashion in FIG. 1 is not illustrated herein for the sake of clarity.

FIG. 5 shows a basic diagram of a ribbon lead element 10 of a symmetrically shielded type after the joining process, in particular after the joining of the configuration in FIG. 4. The one ribbon lead element 10 has two metal-lined film layers 2 in a mirror-inverted configuration as well as, in this case, five leads 16 which are located between them and which are embodied, as in FIG. 4, as symmetrical pairs. Further elements, e.g. conductors for forming contact with the metal layers 8, are dispensed with herein for the sake of clarity. Likewise, the adhesive layer 4 which is applied in a punctiform fashion in FIG. 1 is not illustrated herein for the sake of clarity.

FIG. 6 shows a basic diagram of a ribbon lead element 10 of a symmetrically non-shielded type before the joining process, with two film layers 2 as well as, in this case, four intermediate leads 16, which are embodied in this case, as in FIG. 4, as symmetrical pairs. Further elements are dispensed with herein for the sake of clarity. Likewise, the adhesive layer 4 which is applied in a punctiform fashion in FIG. 1 is not illustrated herein for the sake of clarity.

FIG. 7 shows a basic diagram of a ribbon lead element 10 of a symmetrically non-shielded type after the joining process, in particular after the joining of the configuration from FIG. 6, with two film layers 2 and with, in this case, four intermediate leads 16 which are embodied as symmetrical pairs. Further elements are dispensed with herein for the sake of clarity. Likewise, the adhesive layer 4 which is applied in a punctiform fashion in FIG. 1 is not illustrated herein for the sake of clarity.

It becomes clear from all of FIGS. 2 to 7 that the film layers 2 are adapted to the cross-sectional contour of the leads 16 after the manufacture of the ribbon lead element 10. The film layers 2 bear directly one against the other in the intermediate spaces 18. In the case of metal-lined film layers 2, the metal layers 8 thereof bear one against the other and are placed in electrical contact with one another.

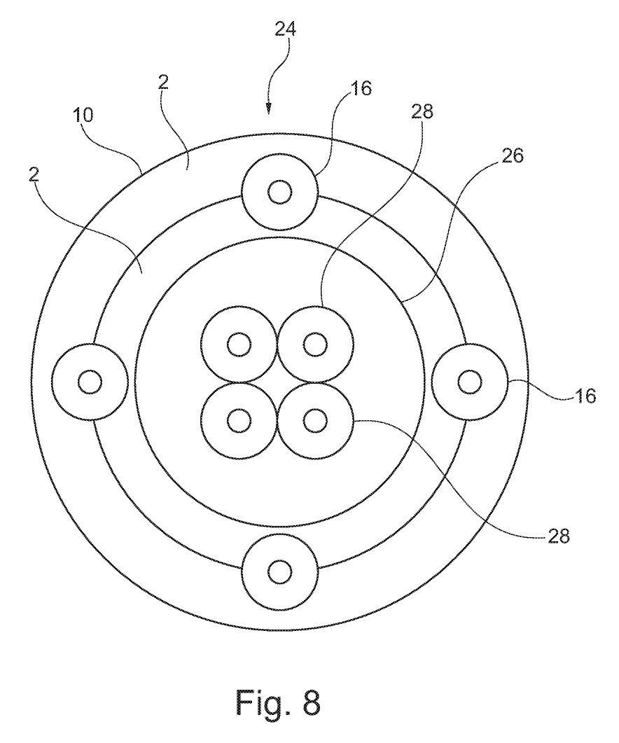

FIG. 8 shows a cable 24 which is embodied as a data transmission cable, in particular a USB cable, with a central element 26 and with a ribbon lead element 10 which is disposed around the central element 26. The film layers 2 are only illustrated in a highly diagrammatic form therein. The ribbon lead element is, in particular, a ribbon lead element 10 according to FIG. 3. In a variant which is not shown, one of the ribbon lead elements 10 according to FIGS. 5 and 7 is used with a suitable number of conductor elements. The central element 26 is embodied as a USB 2.0 cable, with four conductor elements 28. The ribbon lead element 10 has four leads 16, specifically also four conductor elements. As a result of the total of eight conductor elements 16, 28, the cable 24 is then embodied, in particular, as a USB 3.1 cable.

1. A cable or data cable, comprising:
a central element extended in a longitudinal direction; and
a ribbon lead element extended in said longitudinal direction and surrounding or encasing said central element;
said ribbon lead element having two film layers and a plurality of leads or conductor elements disposed between said film layers.

2. The cable according to claim 1, wherein:
said ribbon lead element is a coaxial ribbon lead element having a plurality of coaxial elements;
said film layers are metal-lined film layers each having a conductive side;
said leads are constructed as an inner structure of a coaxial conductor each having an inner conductor surrounded by a dielectric; and
said conductive sides of said film layers face one another and are electrically conductively connected to one another to form a common outer conductor for said coaxial elements.

3. The cable according to claim 1, wherein:
said ribbon lead element is a symmetrically shielded ribbon lead element;
said film layers are metal-lined film layers each having a conductive side;
each two of said leads are combined to form a lead pair being twisted with one another or running parallel to one another; and
said conductive sides are only connected to one another outside said leads of a respective lead pair to form shielded lead pairs.

4. The cable according to claim 1, wherein:
said ribbon lead element is a symmetrically non-shielded ribbon lead element;
said film layers are non-conductive film layers; and
said leads are non-shielded and each two of said leads are combined and twisted with one another to form a non-shielded lead pair.

5. The cable according to claim 1, wherein said ribbon lead element additionally has a plurality of flat conductor elements.

6. The cable according to claim 1, wherein said two film layers are each constructed as a metal-coated or metal-lined film each having a carrier film and a metal layer applied on said carrier film.

7. The cable according to claim 1, which further comprises an adhesive interconnecting said two metal layers, said adhesive being applied only on an area basis or a section basis or only in a punctiform fashion to one or to both of said metal layers.

8. The cable according to claim 1, which further comprises two metal layers each disposed on a respective one of said film layers, and a conductor or a wire or a stranded conductor being electrically connected to both of said metal layers, being placed in electrical contact with both of said metal layers and being disposed between said two metal layers or between two of said leads.

9. The cable according to claim 1, wherein said leads form a cross-sectional contour to which said film layers are adapted, and said film layers bear against one another in regions between each two of said leads.

10. The cable according to claim 1, wherein said two film layers are each part of a common film being folded or longitudinally folded to form said two film layers.

11. The cable according to claim 1, wherein said leads are conductor element pairs having two conductor elements being parallel or twisted with one another.

12. The cable according to claim 11, which further comprises a common lead sheath surrounding said conductor elements.

13. The cable according to claim 1, wherein said film layers are exclusively fabricated from an electrically insulating material.

14. The cable according to claim 1, wherein said ribbon lead element is wound around said central element.

15. The cable according to claim 1, wherein said central element has a plurality of leads, and both said leads of said central element and said leads of said ribbon lead element are constructed to transmit data.

16. The cable according to claim 1, wherein said central element has a plurality of leads being twisted with one another to form a twisted assembly.

17. The cable according to claim 16, wherein said ribbon lead element is wound around said twisted assembly.

18. The cable according to claim 17, which further comprises an outer shield applied to said ribbon lead element.

19. The cable according to claim 1, wherein the cable is a USB cable or a USB 3.1 cable, and said central element and said ribbon lead element each have four respective conductor elements.

20. The cable according to claim 1, wherein said central element is a USB 2.0 cable.

21. A method for manufacturing a cable, the method comprising the following steps:
providing a central element;
providing a ribbon lead element including two film layers and a plurality of leads disposed between the film layers; and
surrounding or encasing the central element with the ribbon lead element.

22. The method according to claim 21, which further comprises winding or longitudinally folding the ribbon lead element around the central element.

23. The method according to claim 21, which further comprises:
constructing the central element as a twisted assembly composed of a plurality of leads or data leads and having a laying direction; and
winding the ribbon lead element around the central element in an opposite laying direction or in a direction opposite to the laying direction of the twisted assembly.

24. A ribbon lead element for a cable, said ribbon lead element comprising:
two film layers; and
a plurality of leads disposed between said film layers.

25. A method for manufacturing a ribbon lead element, the method comprising the following steps:
providing two film layers;
placing a plurality of leads between the two film layers; and
interconnecting or punctiform bonding the film layers to one another.

26. A motor vehicle, comprising a cable according to claim 1.
